(19) United States
(12) Patent Application Publication
(10) Pub. No.: US 2024/0399292 A1
(43) Pub. Date: Dec. 5, 2024

(54) SYSTEMS AND PROCESSES FOR MAINTAINING CONTINUOUS CARBON DIOXIDE CAPTURE UTILISING WASTE EXCESS ENERGY FROM PARALLEL AND DOWNSTREAM PROCESSES

(71) Applicant: SHELL USA, INC., Houston, TX (US)

(72) Inventors: Sayee Prasaad BALAJI, Amsterdam (NL); Mark KLOKKENBURG, Amsterdam (NL); Xiao FU, Amsterdam (NL)

(21) Appl. No.: 18/697,822

(22) PCT Filed: Oct. 18, 2022
(86) PCT No.: PCT/EP2022/078953

§ 371 Date: Apr. 2, 2024

(30) Foreign Application Priority Data
Oct. 21, 2021 (EP) 21204018.2

(51) Int. Cl. B01D 53/14; B01D 53/02

(52) U.S. Cl. CPC B01D 53/1475; B01D 53/02; B01D 53/1425; B01D 2257/504; B01D 2258/06; B01D 2259/4009

(57) ABSTRACT

This invention provides direct air capture (DAC) systems and processes for operating such systems that can operate continuously to remove carbon dioxide from an atmosphere under power from a wide range of intermittent renewable energy sources, and which is supplemented with recycled or excess energy derived from a parallel industrial process.

### FIELD OF THE INVENTION

This invention relates to capture of carbon dioxide from a carbon dioxide containing gas stream, typically from the general atmosphere or from a specially conditioned atmosphere such as one that includes exhaust gases from industrial processes.

### BACKGROUND OF THE INVENTION

Direct air capture (DAC) of carbon dioxide from the air has been proposed as one way of addressing human induced climate change. Current estimates place global levels of carbon dioxide in the atmosphere at around 420 parts per million. This is expected to rise to around 900 parts per million by the end of the 21st century. Hence, DAC represents one of a range of technologies that can be employed to reduce the environmental impact of greenhouse gases like carbon dioxide and help the transition to a low carbon global economy.

Typical DAC systems take large quantities of air (or other conditioned gaseous atmosphere) which is pumped as a feedstream through a unit that contains a sorbent substance that removes the carbon dioxide from the feedstream. Over time the sorbent becomes loaded with captured carbon dioxide. Next, the captured carbon dioxide in the sorbent is extracted from the sorbent in the regeneration step. Regeneration may involve thermal or chemical processes depending upon the type of sorbent material that is selected for use in the DAC. For example, amine-functionalised resins can serve as effective sorbents that are regenerated at temperatures of above 80° C., typically up to 120° C. Upon regeneration the captured carbon dioxide is released from the sorbent and can be used to manufacture sustainable fuels, chemicals, in food and beverage production or in carbon capture and sequestration (CCS) in order to create a net negative carbon process. The energy input to the DAC system can comprise of thermal energy in the form of steam, and electrical energy for both the absorption (to move the air through the DAC unit) and regeneration (to regenerate the CO2 from the sorbent) steps.

The processes typically employed in DAC systems can be capital, energy and resource intensive which is exacerbated by the relatively low concentration of carbon dioxide in the normal atmosphere. Whilst the commercial net cost per ton of carbon dioxide captured is decreasing for current DAC set ups, further realistic operating cost reductions merely through economies of scale and technology maturation are unlikely unless the DAC systems can be powered reliably for extended periods by low cost renewable energy. However, readily available renewable energy sources such as wind and solar only output power intermittently—i.e. when the wind is blowing or the sun is shining. Non-intermittent renewable energy such as from hydropower or geothermal sources is subject to significant limitations and is not available in many countries that lack the appropriate geography, infrastructure or the resources to support the construction of major dam or geothermal energy projects. Hence, it would be desirable to provide DAC systems and set ups that can mitigate for the intermittent power supply from readily available renewable energy sources such as wind, solar PV, concentrated solar power or tidal power.

US-2008/0289495-A and WO-2008/144708-A1 both describe a DAC unit that may be powered by a solar energy collection system. The solar energy may be used to drive a power generator that converts solar energy to thermal energy which, in turn, may be used to generate high pressure steam that feeds a turbine to produce electrical power for the DAC system. The solar energy collection system may be supplemented by other energy supplies derived from fossil fuel combustion, waste incineration, nuclear, biomass or geothermal sources. However, since a DAC unit typically needs heat to regenerate the sorbent, using the waste heat from sources such as fossil fuel combustion to generate power is not efficient. This also does not address the problem of supplying the DAC unit with continuous renewable energy in the form of electrical energy and heat energy. Solar energy is intermittent and in order to operate the DAC unit continuously, an energy storage unit is required to supply electrical energy and thermal energy continuously to the DAC unit.

CN-108671703-A discloses an amine-based DAC system in which electrical energy derived from renewable sources is stored in an accumulator which is used to power a centrifugal blower that directs a gaseous feedstream over the sorbent material. However, this does not address the problem of supplying the DAC unit with a continuous stream of thermal energy that is required for the continuous operation of the DAC unit, in particular for the regeneration of the sorbent.

Breyer et. al. (Breyer, C., Fasihi, M. & Aghahosseini, A. Carbon dioxide direct air capture for effective climate change mitigation based on renewable electricity: a new type of energy system sector coupling. Mitig Adapt Strateg Glob Change 25, 43-65 (2020).

https://doi.org/10.1007/s11027-019-9847-y) describe a system where the DAC units require electricity and heat at about 100° C. for CO2 capture and regeneration. The heat is provided by electrical compression heat pumps. The heat from the heat pumps can be stored in a thermal energy storage before consumption. However, the electrical compression heat pumps are restricted in the temperature of the outlet stream of 100° C., which is not a stream of low pressure or high pressure steam. As a result, the thermal energy storage is restricted to storage of low grade heat of temperatures less than or equal to 100° C. and this can only supply heat of 100° C. or lesser to the DAC unit. They cannot be used to supply steam to the DAC unit that is greater than 100° C.

CN-108786368-A describes a greenhouse system for agriculture that utilises a DAC system for the purpose of enhancing the carbon dioxide atmosphere within the greenhouse. A solar energy absorption device that comprises a concave mirror is used to generate steam that in turn it utilised for regeneration of sorbent material in the DAC.

DAC systems are often incorporated into industrial plants in order to reduce the carbon footprint of such facilities, by capturing carbon dioxide from the carbon dioxide containing gas streams such as air and using them to produce products or sequester them. DAC systems also potentially can benefit from the integration with the industrial plants by utilizing the waste heat streams generated by these plants. It is therefore a problem when intermittent renewable energy sources are used to power the DAC unit (e.g. wind or solar) as this can result in considerable downtime for the DAC whilst parallel or downstream processes continue to operate around the clock. One previous solution to the problem intermittent power supply includes running the DAC unit intermittently and storing the CO₂ as a gas in a buffer tank (see U.S. Pat. No. 10,421,913-B2). This approach increases the complexity of the system and does not address the fundamental problem of discontinuous operation of the DAC.

There is a need to provide improved DAC systems and processes that can operate continuously using a variety of renewable energy sources. These and other objectives will become apparent from the disclosure provided herein.

### SUMMARY OF THE INVENTION

The present inventors provide DAC systems and processes for operating such systems that can operate continuously under power from a wide range of intermittent renewable energy sources. The present invention also combines excess energy, optionally in the form of low pressure steam, that is generated by other parallel or downstream industrial processes with the DAC and energy storage units, thereby optimizing them. Multiple embodiments are possible which use the energy in form of heat, steam, power or hot water to generate either power or steam or both for the DAC unit to operate continuously to produce CO₂ for utilization purposes.

Accordingly, the invention provides in a first aspect, a system for continuous capture of carbon dioxide from a gaseous feedstream, the system comprising: an energy storage unit for receiving, storing and continuously discharging energy; and a DAC unit,

wherein the energy storage unit receives a first supply of energy from an intermittent renewable source of energy; and a second supply of energy that comprises excess energy recycled from a parallel or downstream industrial process.

In a specific embodiment, the system further comprises a steam generator, wherein the steam generator is configured to provide a supply of steam to the DAC unit and wherein the steam generator receives energy, such as electrical energy, from the energy storage unit. Suitably the supply of steam may be low pressure steam and/or high pressure steam. Optionally, the steam generator is comprised within the energy storage unit.

In a further embodiment the energy provided by either or both of the first and second supply is suitably in the form of thermal energy. In embodiments of the invention the thermal energy is in the form of low pressure steam. Additionally, in other embodiments of the invention, the thermal energy can also be, but not restricted to, in the form of high pressure steam, hot water, hot oil, molten salts, heat transfer fluids, hot gaseous streams. In a further embodiment the thermal energy provided to the energy storage unit via a heat transfer fluid. Suitably, the energy storage unit comprises a thermal storage medium.

In yet a further embodiment, the system further comprises an electrical generator which is configured to receive a supply of high pressure steam from the steam generator. In an alternative embodiment, the system further comprises an electrical generator which is configured to receive a supply of high pressure steam from a downstream or parallel industrial process.

In a further embodiment, the energy provided by the second supply is suitably in the form of electrical energy. In another embodiment of the invention, the electrical energy can be directly supplied to the DAC unit.

In a further embodiment, the energy provided by the renewable source of energy is in the form of electrical energy—i.e. electrical power. Accordingly, in a specific embodiment the energy storage unit further comprises an electrical storage unit. Optionally, the electrical storage unit is in electrical connection with the steam generator and/or the DAC unit.

A second aspect of the invention provides a process for continuous capture of carbon dioxide from a gaseous feedstream, wherein the process comprises providing a first source of renewable energy, combined with at least a second source of energy that comprises excess energy recycled from a parallel or downstream industrial process, in order to provide a continuous source of operating power to a DAC unit. Optionally, the source of renewable energy is selected from one or more of the group consisting of: solar thermal; solar photovoltaic; wind; geothermal; wave; and tidal. In a particular embodiment the gaseous feedstream comprises atmospheric air and/or a carbon dioxide containing exhaust gas.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any described embodiment can be combined with other embodiments in any way and/or combination, unless such features are incompatible.

### BRIEF DESCRIPTION OF THE DRAWINGS

FIG. 1 illustrates a schematic of a continuously operating system according to an embodiment of the invention;

FIG. 2 illustrates a schematic of a continuously operating system according to another embodiment of the invention

FIG. 3 illustrates a schematic of a continuously operating system according to a further embodiment of the invention.

FIG. 4 illustrates a schematic of a continuously operating system according to yet a further embodiment of the invention.

FIG. 5 illustrates a schematic of a continuously operating system according to a further embodiment of the invention.

FIG. 6 illustrates a schematic of a continuously operating system according to yet a further embodiment of the invention.

### DETAILED DESCRIPTION OF THE INVENTION

In general terms the present invention provides system comprising a DAC unit for capturing carbon dioxide from a gaseous feedstream with a sorbent material, and for regenerating said sorbent using energy from at least a primary source of energy that consists of an intermittent renewable source of energy, and a secondary source of energy that comprises excess or recycled process energy from a parallel operating industrial process. The system of the invention further comprises an energy storage unit for receiving, storing, and discharging the energy from these combined sources thereby enabling the DAC unit to operate continuously—e.g. throughout the day/night cycle and at all times of the year. Hence, the term “continuously” is intended to mean substantially without interruption. However, it will be appreciated that interruptions for routine maintenance or repair may need to occur, nevertheless, the systems and processes of the invention are intended to facilitate substantially continuous operation of a DAC system irrespective of the nature of the renewable energy/power source it is ultimately reliant upon. In this arrangement the secondary source of energy supplements and compensates for the intermittent nature of the primary renewable supply but does so without need to generate additional energy via consumption of fuel (e.g. fossil fuel). It is highly advantageous that the systems and processes of the invention, therefore, allow for continuous operation of the DAC with minimal down time.

For the purposes of promoting an understanding of the principles of the invention, reference will now be made to the embodiments illustrated in the accompanying drawings, which are described in more detail below. The embodiments disclosed herein are not intended to be exhaustive or limit the invention to the precise form disclosed in the following detailed description. The invention includes any alterations and further modifications in the illustrated devices and described methods and further applications of the principles of the invention as set forth in the claims.

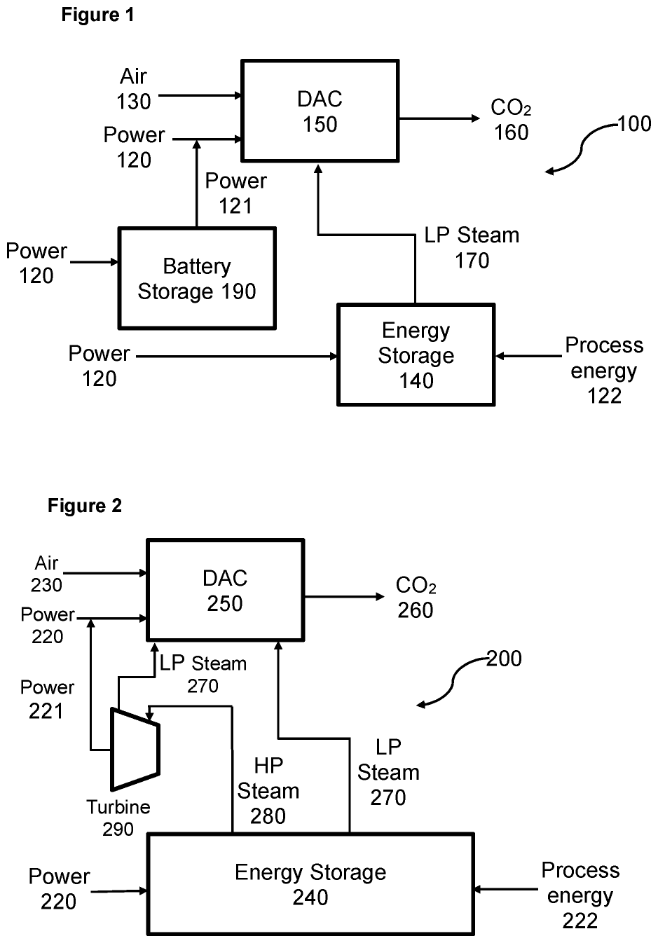

FIG. 1 shows a DAC system and process 100 according to a first embodiment of the present invention. A renewable energy source (not shown) provides a primary source of electrical power 120 to the system 100. A portion of the power supply 120 is directed to a battery storage 190 such as a battery or electrical energy cell. The storage unit 190 can provide supply electrical power 121 that can be used in the operation of the system 100 as a whole or mainly of the DAC unit 150. Another portion of the power supply 120 is directed to an energy storage unit 140 that comprises a thermal storage medium. The primary supply to the energy storage unit 140 is supplemented by an additional secondary source of process energy 122 which is derived from coupling with parallel industrial processing apparatus and systems that generates excess or waste energy, suitably in the form of thermal energy, such as comprised within steam or other heated fluids. By way of non-limiting example, excess thermal energy may be generated from co-located processes such as reverse water gas shift, methanation, methanol production, Fischer-Tropsch process, natural gas liquefaction, regasification, pyrolysis, crude oil refining, chemicals manufacture, hydrogen electrolysers (low and high temperature) and syngas electrolysers (especially high temperature). However, it will be appreciated that co-location of the presently described processes with any broadly exothermic industrial or biotechnological process is suitable to provide a secondary supply of process derived thermal energy. Alternatively, the secondary source of energy supply can also be in the form of electrical energy.

The energy storage unit 140 may comprise a heat storage medium such as molten salts and/or a heat exchanger. The energy storage unit 140 may use either direct or indirect heat exchange methods. For example, if the renewable energy source comprises a solar photovoltaic or wind or tidal apparatus, the power supply 120 is in the form of electrical energy. This electrical energy may be further converted to thermal energy by means such as direct or indirect heat exchange methods. The thermal energy is further stored in a suitable medium comprising a heat transfer fluid (HTF) such as a conducting oil (mineral oil or synthetic oil), or water in conjunction with liquid molten salt or a powdered packed bed salt. Liquid-phase storage materials are typically used in so called “Active Thermal Energy Storage” systems, where storage materials circulate through heat exchangers and collectors.

The energy storage unit 140, 240, 340, 441, 640 as utilised in any one of the embodiments of the invention may comprise an electrode layer that comprises a powder bed of a semiconductor material having an electrical resistivity of in the range of 500-50,000 Ωm. A plurality of electrodes are embedded in the powder bed and arranged to heat the powder bed by providing a voltage therebetween. The semiconductor material may, for example, comprise silicon carbide (SiC), optionally doped with a suitable amount of nitrogen, phosphorus, beryllium, boron, aluminium, or gallium to obtain the desired electrical resistivity. Doped silicon carbide has excellent electrical and thermal properties (in terms of conductance and storage capacity) for use in the electrode layer of the energy storage unit 140, 240, 340, 441, 640. Such doped silicon carbide may, for example, have an electrical resistivity of about 1,000 Ωm for use with an intermediate transmission grid supply voltage. Because of impurities in the bulk production of silicon carbide, undoped silicon carbide may be suitable for use as the main ingredient of the powder bed too. Undoped silicon carbide with a resistivity of up to 50,000 Om may, for example, be used with a high transmission grid supply voltage.

The resistivity of the powder bed does not only depend on the material of the powder bed particles used, but also on, e.g., particle size, particle shape, and the spacing between the particles. The electrical resistivity of the powder bed is preferably selected in such a way that the energy storage unit 140, 240, 340, 441, 640 can be connected directly to an electric energy supply, such as a wind farm, solar farm, or tidal barrage without requiring the use of any transformers for first converting the high voltage of the electrical power supply to a much lower voltage that can be used for heating the electrically conductive medium between the electrodes. Such a direct connection to the intermittent electrical power source allows the selected semiconductor material to simultaneously fulfil the functions of energy conversion and energy storage resulting in a significant cost reduction.

The energy storage unit 140, 240, 340, 441, 640 may comprise a heat exchange system that is able to heat a supply of water by way of a boiler and generate output of high pressure (HP) steam and also low pressure (LP) steam. In the present systems, high pressure steam is typically considered to be steam at a pressure in excess of 500 kPa (approximately 72.5 psi) whereas low pressure steam is less than around 500 kPa. A high pressure steam line directs the steam to a steam turbine, such as a back pressure turbine, for generation of electrical power that can be used in the operation of the systems, e.g. in the operation of impellers such as fans that control the intake of gaseous atmosphere such as air into the DAC unit. Low pressure steam that may be vented from the turbine may be directed to the DAC unit as described in specific embodiments further below, via a low pressure steam line. In an alternative embodiment a condensing turbine may be used in which vented steam is instead directed to a condenser to allow for collection of the water. Electrical power provided by way of the energy storage unit 140, 240, 340, 441, 640 may, therefore, supplement an intermittent power supply provided by the renewable energy source.

Returning to the embodiment set out in FIG. 1, one or more low pressure steam lines 170 provide a conduit for fluid communication between the energy storage unit 140 and the DAC unit 150. Low pressure steam is generated and used in the regeneration of the sorbent materials within the DAC unit 150. Upon regeneration of sorbent materials within the DAC unit 150, carbon dioxide (CO₂) is released and conveyed out of the DAC unit 150 via a carbon dioxide conduit 160 where it may be utilised in a range of industrial/agricultural processes or stored or sequestered as necessary. Residual steam or water may be vented or recycled to the energy storage unit 140.

FIG. 2 shows a DAC system and process 200 according to a second embodiment of the present invention. A renewable energy source (not shown) supplies electrical power 220 to the system 200. A portion of the power 220 is directed as a primary supply to the energy storage unit 240 that comprises a thermal storage medium. The primary supply to the energy storage unit 240 is supplemented by an additional secondary source of process energy 222 which is derived from coupling with a parallel industrial processing apparatus or system that generates excess or waste energy, suitably in the form of thermal energy, such as comprised within steam or other heated fluids. The secondary source of energy supply can also be in the form of electrical energy. The energy storage unit 240 may comprise a heat storage medium such as molten salts and/or a heat exchanger as described previously.

The energy storage unit 240 comprises a heat exchange system that is able to heat a supply of water by way of a boiler and generate output of high pressure (HP) steam and also low pressure (LP) steam. In the present systems, high pressure steam is typically considered to be steam at a pressure in excess of 500 kPa (approximately 72.5 psi) whereas low pressure steam is less than around 500 kPa. A high pressure steam line 280 directs the steam to a back pressure steam turbine 290 for generation of electrical power 221 that can be used in the operation of the system 200, for instance as in the operation of impellers such as fans that control the intake of gaseous atmosphere such as air 230 into the DAC unit 250. Low pressure steam that may be vented from the turbine 290 may be directed to the DAC unit as described further below, via a low pressure steam line 270. Electrical power 221 provided by way of the energy storage unit 240 may, therefore, supplement or replace an optional external electrical power supply 220, for example provided by an intermittent renewable power source.

One or more low pressure steam lines 270 provide a conduit for fluid communication between the energy storage unit 240 and the DAC unit 250 (optionally via the turbine 290). Low pressure steam is used in the regeneration of the sorbent materials within the DAC unit 250. Upon regeneration of sorbent materials within the DAC unit 250, carbon dioxide is released and conveyed out of the DAC unit 250 via a carbon dioxide conduit 260 where it may be utilised in a range of industrial/agricultural processes or stored or sequestered as necessary. Residual steam or water may be vented or recycled to the energy storage unit 240.

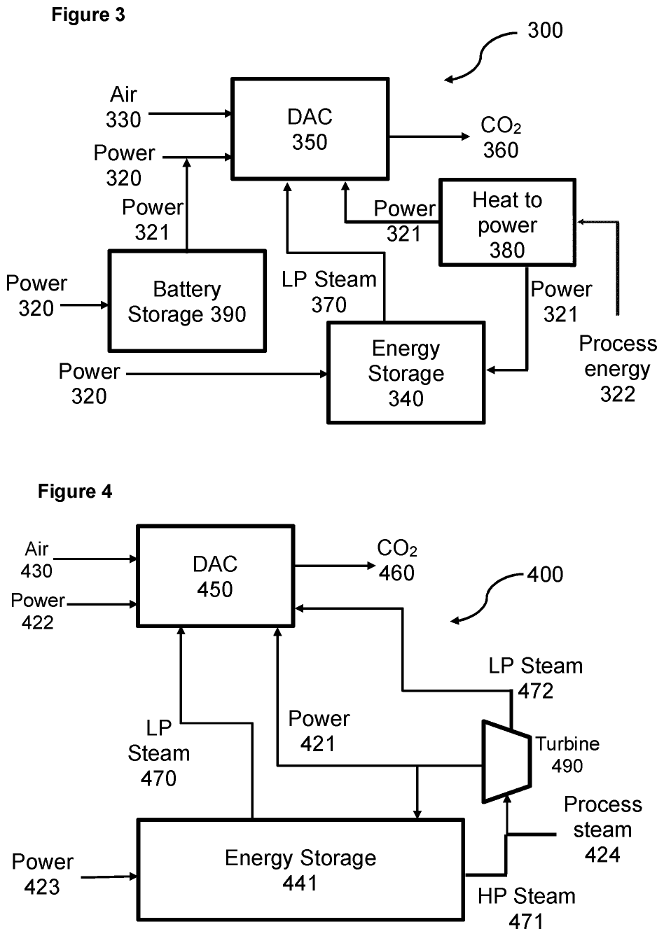

FIG. 3 shows a third embodiment of a system and process of the present invention 300 that is similar to the process described and illustrated in FIG. 1. In the system 300 of FIG. 3, a renewable energy source (not shown) provides a primary source of electrical power 320 to the system 300. A portion of the power supply 320 is directed to the battery storage 390 such as a battery or electrical energy cell. The storage unit 390 can provide supply electrical power 321 that can be used in the operation of the system 300 as a whole or mainly of the DAC unit 350. Another portion of the power supply 320 is directed to an energy storage unit 340 that comprises a thermal storage medium. The primary supply to the energy storage unit 340 is supplemented by an additional secondary source of process energy 322 which is derived from coupling with parallel industrial processing apparatus and systems that generates excess or waste energy, suitably in the form of thermal energy, such as comprised within steam or other heated fluids. Process energy 322 which may be in the form of thermal energy conveyed, for example, by way of a working fluid is introduced into a heat to power unit 380, such as a turbine that converts the heat energy to electrical energy. Power from the unit 380 may be supplied to the DAC 350 to further supplement the intermittent supply 320. Optionally, surplus power 321 from the unit 380 may also be stored in the energy storage unit 340.

FIG. 4 shows an alternative configuration to the previous embodiment shown in FIG. 3. In the system 400 of FIG. 4, a renewable energy source (not shown) provides a primary source of electrical power to the system 400. A portion of the power supply 423 is directed to an energy storage unit 441 that comprises a thermal storage medium. The primary supply 423 to the energy storage unit 441 is supplemented by an additional secondary source of process energy in the form of high pressure steam which is derived from coupling with parallel industrial processing apparatus and systems as described previously. Process steam is conveyed via a steam line 424 to a turbine 490. The turbine 490 may be in the form of a back pressure turbine, in which low pressure exhaust steam is vented via a line 472 to the DAC 450 for sorbent regeneration. Alternatively, a condensate turbine may be used in which water and low pressure steam is vented and water captured for use in other processes (not shown). Electrical power generated by the turbine 490 may be supplied to the DAC 450 to further supplement the intermittent power supply 422. Optionally, surplus power 421 from the turbine 490 may also be stored in the energy storage unit 441. The energy storage unit 441 may generate low pressure steam 470 for supply to the DAC, as described previously. In addition, high pressure steam 471 may be produced by the energy storage unit 441 and routed to the turbine 490 as required for additional power generation.

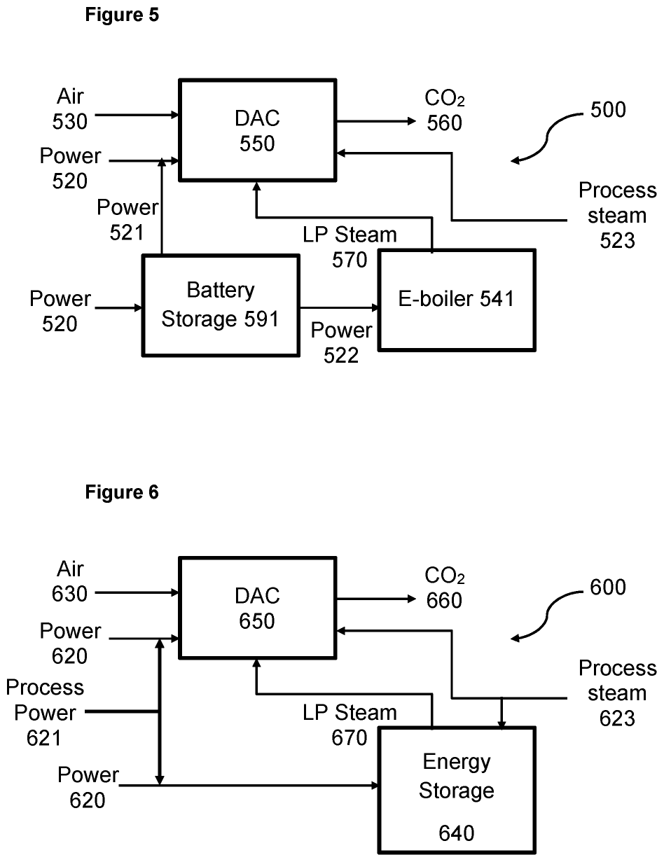

FIG. 5 shows another embodiment of a system and process of the present invention 500 in which a renewable energy source (not shown) supplies electrical power 520 to the system 500. A portion of the power supply 520 may also be used to supply the DAC unit 550 which removes carbon dioxide from a feedstream of a gaseous atmosphere such as air 530. However, as described in the previous embodiments, this power supply 520 may be subject to interruption. A portion of the power supply 520 is directed to an electrical storage unit 591. The electrical storage unit 591 can supply electrical power 521 that can be used in the operation of the system 500 as a whole or simply of the DAC unit 550 when the power supply 520 from renewable energy source is interrupted.

Electrical power 522 may also be supplied by the electrical storage unit 591 to an electrically powered water boiler (i.e. an E-boiler) 541, such as an immersion heater, to generate low pressure steam. A low pressure steam line 570 provides a conduit for fluid communication between the boiler 541 and the DAC unit 550. This allows for the low pressure steam to be used in the regeneration of the sorbent materials within the DAC unit 550. Upon regeneration of sorbent materials within the DAC unit 550, carbon dioxide is released and conveyed out of the DAC unit 550 via a carbon dioxide conduit 560. Steam from the water boiler 541 may be supplemented with steam which is derived from coupling with parallel industrial processing apparatus and systems as described previously. Process steam is conveyed via a steam line 523 to the DAC 550. As described previously, residual water or steam may be vented or recycled as needed within the system 500.

In a further embodiment of the invention, shown in FIG. 6, a primary renewable energy source (not shown) supplies electrical power 620 to the system 600. A portion of the power supply 620 may also be used to supply the DAC unit 650. However, as described in the previous embodiments, this power supply 620 may be subject to interruption. A portion of the power supply 620 is directed to an energy storage unit 640 that comprises a thermal storage medium, as described previously. The primary supply 620 to the system 600 may be supplemented by an additional secondary source of process power 621 which is derived from energy from coupling with parallel industrial processing apparatus and systems as described previously. One or more low pressure steam lines 670 provide a conduit for fluid communication between the energy storage unit 640 and the DAC unit 650. Low pressure steam is generated by the energy storage unit 640 and used in the regeneration of the sorbent materials within the DAC unit 650. Upon regeneration of sorbent materials within the DAC unit 650, carbon dioxide (CO₂) is released and conveyed out of the DAC unit 650 via a carbon dioxide conduit 660. Low pressure steam produced by the energy storage unit 640 may be supplemented with additional process steam 623 that is directed to the DAC 650, or optionally routed to the energy storage unit 640.

It is a particular advantage of the systems of the invention as described herein, that they provide power and steam compensation to supplement periodic loss of capacity in conventional DAC systems. Hence, the embodiments of the invention described herein allow not only for the continuous operation of a DAC unit in terms of uninterrupted electrical power supply but also uninterrupted sorbent regeneration. This removes the requirements to ramp up or ramp down the systems in response to power availability and demand.

In a specific embodiment of the invention the systems described herein may comprise one or more control units that monitor power supply and provide a balancing function between drawing on power provided by the energy/heat storage unit and the direct power supply to the DAC unit that may be provided by an intermittent energy supply. The system control unit may comprise one or more computers (e.g. CPUs) that are in direct electrical communication with the various components of the systems, or which monitor the systems via remote telemetry (e.g. via a cloud based remote monitoring system).

The invention is further exemplified in the following non-limiting example.

### Example

The following example refers to a modelled system and process as explained in the different embodiments of the present disclosure. Table 1 illustrates the assumed specifications for an exemplary DAC unit at a particular location.

TABLE 1

| | | |
|---|---|---|
| Rate of CO2 captured | 100 | tons/hr |
| Thermal energy demand | 300 | MW |
| Electrical energy demand | 40 | MW |
| Desired run time of DAC unit | 24 | hours/day |

Renewable energy is required to power the DAC unit. The chosen location has an assumed constant solar irradiation profile for 8 hrs every day throughout the year. A solar photovoltaic array is used to provide renewable energy in the form of electrical energy to the DAC unit. A storage unit is required to supply thermal energy and electrical energy to the DAC unit for balance of 16 hours every day in order to keep the DAC unit operating continuously. Additionally, an assumed continuous stream of thermal energy rated at 100 MW is available from the downstream industrial process, which can be used by the system.

Since the DAC unit requires both thermal and electrical energy, part of the renewable electrical energy is converted to thermal energy. This thermal energy is stored in the form of heat storage as described in the embodiments of the present disclosure. The rest of the electrical energy is stored as is in the electrical energy storage unit. The continuous stream of thermal energy from the downstream process is used directly by the DAC unit. Table 2 illustrates the assumed efficiencies of the different storage units including conversion of electrical energy to thermal energy.

TABLE 2

| | |
|---|---|
| Efficiency of the heat storage unit | 100% |
| Efficiency of the electrical storage unit | 90% |
| Efficiency of conversion of electrical energy to thermal | 99% |
| energy | |

Table 3 illustrates the estimated sizing of the Solar photovoltaic array required for the DAC unit to operate continuously along with the sizing of the electrical and thermal storage units based upon the assumptions made in Tables 1 and 2.

TABLE 3

| | | |
|---|---|---|
| Total storage time required | 16 | hours/day |
| Electrical energy required | 40 | MW |
| for the DAC unit | | |
| Electrical energy storage | 40 | MW |
| unit discharge capacity | | |
| Electrical energy storage | 640 | MWh |
| unit size | | |
| Electrical energy required | 89 | MW |
| for storage unit | | |
| Total electrical energy | 129 | MW |
| required to satisfy DAC | | |
| electrical energy demand | | |
| Thermal energy required for | 300 | MW |
| DAC unit | | |
| Thermal energy available | 100 | MW |
| from downstream process | | |
| Net thermal energy required | 200 | MW |
| for the DAC unit | | |
| Thermal energy storage unit | 200 | MW |
| discharge capacity | | |
| Thermal energy storage unit | 3200 | MWh |
| size | | |
| Total thermal energy | 600 | MW |
| required to satisfy DAC | | |
| thermal energy demand | | |
| Total electrical energy | 606 | MW |
| required to satisfy DAC | | |
| thermal energy demand | | |
| Total size of solar | 735 | MW |
| photovoltaic array | | |

Thus, in order for the DAC unit, with the energy requirements as specified in Table 1, located in a particular location, to be operated continuously only with renewable power along with the constant stream of thermal energy from downstream process, a solar photovoltaic array of 735 MW is required along with electrical and thermal energy storage units. The size of the thermal energy storage unit is 606 MW, and the size of the electrical energy unit is 129 MW. Utilising waste process energy significantly reduces the requirement for renewable energy supply to maintain continuous operation of the DAC system. This also increase the robustness of the overall system and resilience to periods of extended interruption or downgrade of renewable power—e.g. extended periods of overcast conditions for solar PV, or less windy conditions for wind power.

1. A system for continuous capture of carbon dioxide from a gaseous feedstream, the system comprising:
an energy storage unit for receiving, storing and continuously discharging energy; and
a DAC unit,
wherein the energy storage unit receives a first supply of energy from an intermittent renewable source of energy and a second supply of energy that comprises excess energy recycled from a parallel or downstream industrial process;
a steam generator, wherein the steam generator is configured to provide a supply of steam to the DAC unit, and wherein the steam generator receives energy from the energy storage unit; and wherein the steam generator is comprised within the energy storage unit; and
wherein the energy storage unit comprises a thermal storage medium.

2. The system of claim 1, wherein supply of steam is low pressure steam and/or high pressure steam.

3. The system of claim 1, wherein the system further comprises an electrical generator which is configured to receive a supply of high pressure steam from the steam generator.

4. The system as claimed in claim 1, wherein the energy provided by the renewable source of energy is in the form of electrical energy.

5. The system as claimed in claim 1, wherein the system further comprises an electrical storage unit.

6. The system as claimed in claim 5, wherein the electrical storage unit is in electrical connection with the steam generator and/or the DAC unit.

7. The system as claimed in claim 1, wherein the electrical energy is converted to thermal energy prior to storage within the energy storage unit.

8. The system as claimed in claim 1, wherein second supply of energy is in the form of thermal energy.

9. The system of claim 8, wherein the thermal energy is comprised within steam.

10. The system of claim 9, wherein the steam is additionally provided directly to the DAC.

11. A process for continuous capture of carbon dioxide from a gaseous feedstream comprising atmospheric air and/or a carbon dioxide containing exhaust gas, wherein the process comprises providing a first source of renewable energy, combined with at least a second source of energy that comprises excess energy recycled from a parallel or downstream industrial process, to a system as set out in claim 1, and operating the system.

12. The process of claim 11, wherein the source of renewable energy is selected from one or more of the group consisting of: solar thermal; solar photovoltaic; wind; geothermal; wave and tidal.
